(19) United States
(12) Patent Application Publication
(10) Pub. No.: US 2022/0301363 A1
(43) Pub. Date: Sep. 22, 2022

(54) DYNAMIC VEHICLE CLASSIFICATION

(71) Applicant: Swhoon, Inc., Redwood City, CA (US)

(72) Inventor: Eric Richard David Frasch, Redwood City, CA (US)

(21) Appl. No.: 17/697,886

(22) Filed: Mar. 17, 2022

Related U.S. Application Data
(60) Provisional application No. 63/162,075, filed on Mar. 17, 2021.

(51) Int. Cl. G07C 5/02; G07C 5/00; G06Q 30/02; G01S 19/01; G01P 15/00; G01P 13/00

(52) U.S. Cl. CPC G07C 5/02; G07C 5/008; G06Q 30/0269; G01S 19/01; G01P 15/00; G01P 13/00

(57) ABSTRACT

Systems and methods describe providing a dynamic classification of a vehicle based on motion data captured from sensors. In one embodiment, the system receives motion data for a vehicle, the motion data being captured from one or more sensors; processes the motion data for adjustments; determines maximum acceleration data for the vehicle; calculates a performance metric for the vehicle based on the maximum acceleration data; assigns one or more designations to the vehicle based on the performance metric; and presents the one or more designations of the vehicle to one or more users of a network-connected platform. In some embodiments, designations may relate to, for example, racing classes for vehicles entering into racing competitions, or handicap designations to level the playing field among different racing competitors.

### CROSS-REFERENCE TO RELATED APPLICATIONS

This application claims the benefit of U.S. Application No. 63/162,075 filed on Mar. 17, 2021, which is incorporated herein by reference in its entirety.

### FIELD OF INVENTION

The present invention relates generally to vehicle classification, and more particularly, to systems and methods for providing dynamic classification of vehicles within a network-connected platform.

### SUMMARY

The appended claims may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3 is a diagram illustrating one example embodiment of using motion data to provide class designations for vehicles.

FIG. 4 is a diagram illustrating one example of a standard acceleration plot of a vehicle.

FIG. 5 is a diagram illustrating one example embodiment of a sensor external to a vehicle for capturing motion data.

FIG. 6 is a diagram illustrating one example embodiment of a vehicle classification system based on combined G range.

FIG. 7 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In the current state of the racing industry, vehicle classification is normally performed based on lengthy, often convoluted and elaborate sets of rules that a racer must adhere to. A myriad number of factors can affect classification of their vehicles, and the class designation and/or handicap level assigned to a vehicle can be a decisive factor in that racer's success or failure. Examples of rules which racers must take into consideration include, e.g., engine displacement under a certain amount, specific tires which must be used, minimum weight requirements, restriction of modifications, and much more. There are also rigidly enforced rules on the type of vehicle which may be used in each class based on, e.g., the year, manufacturer, and model, often leading to heated debates among racers and fans over the relative merits of one make or model over another.

Some racing organizations, for example, split vehicles into different class designations based on, e.g., power-to-weight ratios and wheel base. The power of the cars can be determined in such instances by using a dynamometer and scales to determine the weight of the car at an approved measurement shop.

In human-powered racing, such as running, swimming, and biking, classification is done by age or racing times, rather than such detailed technical measurements of equipment used. In autocross, however, a racing handicap is typically calculated using a system called Professional Autocross Index/Racers Theoretical Performance (PAX/RTP). Under this system, handicaps are calculated by using the results of autocross racing events around the country. The PAX/RTP is updated each year with the current year's results. In other forms of motorsports, competition of similar vehicles is often controlled using Balance of Performance by limiting power, adding weight, restricting aerodynamics, and more.

Currently, sensor data, such as accelerometers or GPS-equipped devices, are used to classify a user's movement into types of activities, such as, e.g., an exercise watch or heart rate sensors that can identify that a user is running, biking, or performing some other physical activity. However, sensor data is not leveraged for purposes of classifying vehicles for racing or other purposes, particularly to provide vehicle classifications in a way that removes the need for complicated rules and restrictions which a racer must adhere to, and also removes the need for racers to pay close attention to the relative merits of different makes and models of vehicles.

Thus, there is a need in the field of vehicle classification to create a new and useful system and method for providing dynamic vehicle classification based on the use of sensors which capture motion data. The source of the problem, as discovered by the inventors, involves at least a lack of real-world motion data collection and preparation for vehicles, and lack of leveraging that motion data to provide fair classification designations which can be applied across different car makes, different modifications applied to vehicles, and more.

In one embodiment, the system receives motion data for a vehicle, the motion data being captured from one or more sensors; processes the motion data for adjustments; determines maximum acceleration data for the vehicle; calculates a performance metric for the vehicle based on the maximum acceleration data; assigns one or more designations to the vehicle based on the performance metric; and presents the one or more designations of the vehicle to one or more users of a network-connected platform. In some embodiments, designations may relate to, for example, racing classes for vehicles entering into racing competitions, or handicap designations to level the playing field among different racing competitors.

Further areas of applicability of the present disclosure will become apparent from the remainder of the detailed description, the claims, and the drawings. The detailed description and specific examples are intended for illustration only and are not intended to limit the scope of the disclosure.

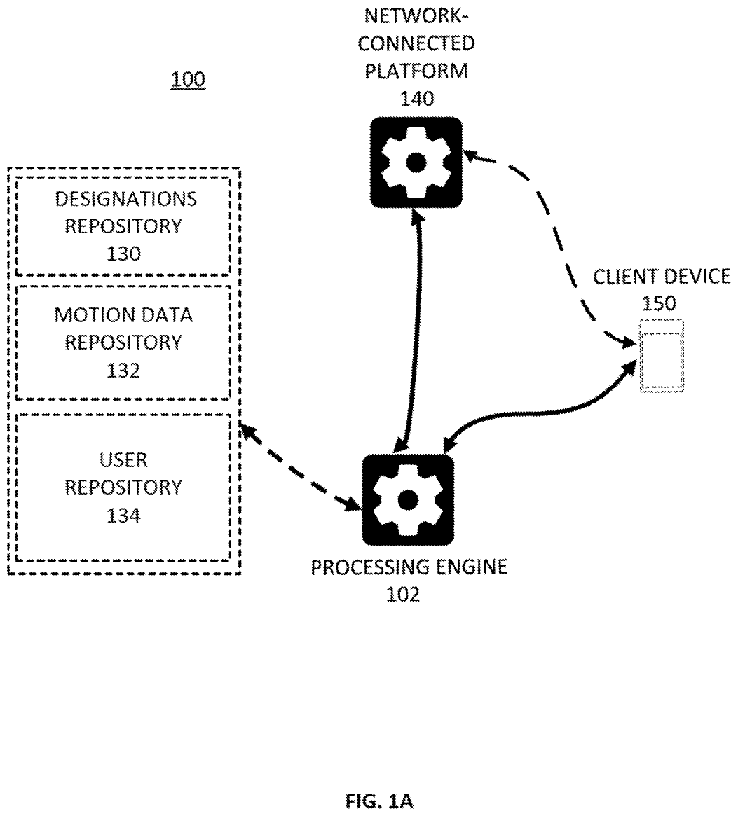

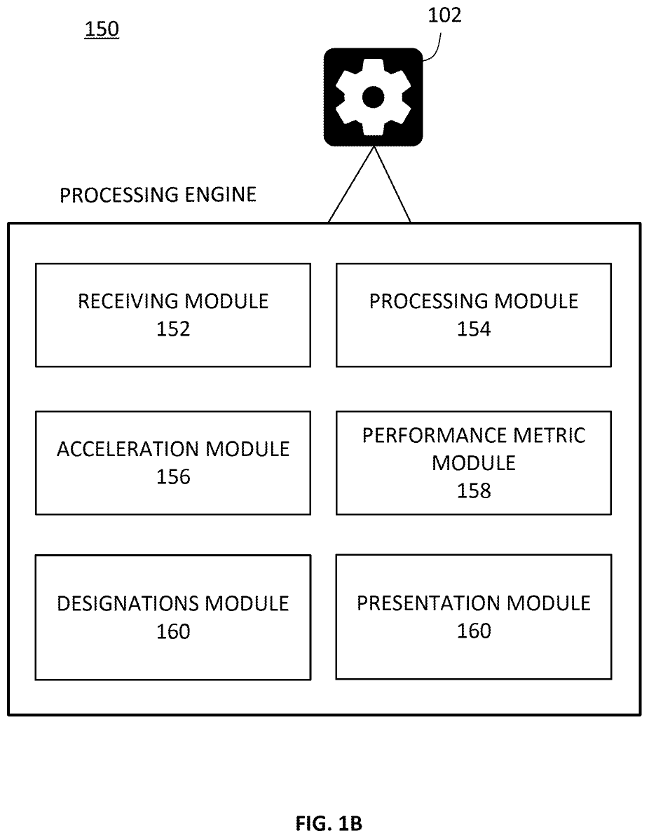

FIG. 1A is a diagram illustrating an exemplary environment in which some embodiments may operate. In the exemplary environment 100, a client device 150 is connected to a processing engine 102 and a network-connected platform 140. The processing engine 102 is connected to the network-connected platform 140, and optionally connected to one or more repositories and/or databases, including, e.g., a designations repository 130, a motion data repository 132, and/or a user repository 134. One or more of the databases may be combined or split into multiple databases. The client device 150 in this environment may be a computer, and the network-connected platform 140 and processing engine 102 may be applications or software hosted on a computer or multiple computers which are communicatively coupled via remote server or locally.

The exemplary environment 100 is illustrated with only one client device, one processing engine, and one network-connected platform, though in practice there may be more or fewer additional client devices, processing engines, and/or network-connected platforms. In some embodiments, the client device(s), processing engine, and/or network-connected platform may be part of the same computer or device.

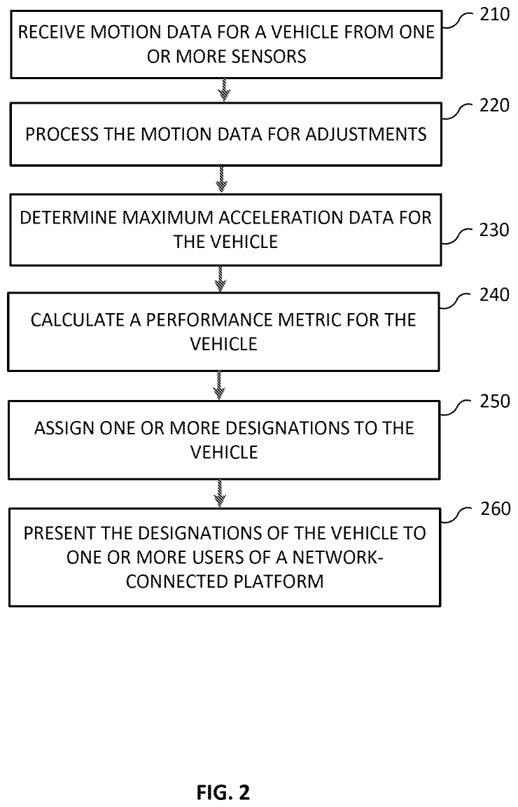

In an embodiment, the processing engine 102 may perform the exemplary method of FIG. 2 or other method herein and, as a result, present one or more vehicle designations to user(s) within the network-connected platform. In some embodiments, this may be accomplished via communication with the client device, processing engine, network-connected platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The client device 150 is a device capable of capturing, sending, and receiving data. In some embodiments, the client device 150 is configured to capture motion data via one or more sensors attached to or otherwise communicatively coupled to the device, and is further configured to send that motion data to the processing engine 102 and/or network-connected platform 140, as well as to receive signals from those components. In some embodiments, the client device is a computing device capable of hosting and executing one or more applications or other programs capable of capturing, sending and/or receiving data. In some embodiments, the client device may be a computer desktop or laptop, mobile phone, virtual assistant, virtual reality or augmented reality device, wearable, or any other suitable device capable of capturing, sending, and receiving information. In some embodiments, the processing engine 102 and/or network-connected platform 140 may be hosted in whole or in part as an application or web service executed on the client device 150. In some embodiments, one or more of the network-connected platform 140, processing engine 102, and client device 150 may be the same device. In some embodiments, the client device 150 is associated with a first user account within a network-connected platform, and one or more additional client device(s) may be associated with additional user account(s) within the network-connected platform.

In some embodiments, optional repositories can include a designations repository 130, a motion data repository 132, and/or a user repository 134. The optional repositories function to store and/or maintain, respectively, information on possible designations (e.g., classes, handicaps, or other similar designations) to be assigned to vehicles; motion data and associated data which may be derived thereof; and data relating to users associated with the vehicles and their preferences and behaviors within the platform. The optional database(s) may also store and/or maintain any other suitable information for the processing engine 102 or network-connected platform 140 to perform elements of the methods and systems herein. In some embodiments, the optional database(s) can be queried by one or more components of system 100 (e.g., by the processing engine 102), and specific stored data in the database(s) can be retrieved.

Network-connected platform 140 is a platform configured to facilitate the determination and presentation of vehicle classifications based on captured motion data, in coordination with users who are associated with particular vehicles, e.g. their chosen racing vehicles or otherwise vehicles they utilize for driving purposes. In various embodiments, the platform 140 may additionally present advertising content, educational content including driving classes, or other content. In some embodiments, this content is customized to a user and/or their associated vehicles and designated classes, handicaps, or other designations of those vehicles.

FIG. 1B is a diagram illustrating an exemplary computer system 150 with software modules that may execute some of the functionality described herein. In some embodiments, the modules illustrated are components of the processing engine 102.

Connection module 152 functions to connect to a communication session with a number of participants, and receive a transcript of a conversation between the participants produced during the communication session.

Receiving module 152 functions to receive motion data for a vehicle, the motion data being captured from one or more sensors.

Processing module 154 functions to process the motion data for adjustments.

Acceleration module 156 functions to determine maximum acceleration data for the vehicle.

Performance metric module 158 functions to calculate a performance metric for the vehicle based on the maximum acceleration data.

Designations module 160 functions to assign one or more designations to the vehicle based on the performance metric.

Presentation module 160 functions to present the one or more designations of the vehicle to one or more users of a network-connected platform.

The above modules and their functions will be described in further detail in relation to an exemplary method below.

FIG. 2 is a flow chart illustrating an exemplary method that may be performed in some embodiments.

At step 210, the system receives motion data for a vehicle, the motion data being captured from one or more sensors. In various embodiments, the one or more sensors could be sensors, or connected devices with embedded sensors or communicatively connected to sensors, of potentially many different types. For example, the types of sensor could be one or more of, e.g., a GPS-equipped device or sensor capable of transmitting GPS coordinates, accelerometer-equipped sensors, phones with a myriad number of embedded sensors, satellites, computers, cameras, microphones, optical sensors, magnetic sensors, radar, gyroscopes, or any other suitable sensor or device connected to sensors.

In various embodiments, the motion data being received by the system, which has been captured by the sensors, may include one or more of, e.g., vehicle acceleration, velocity, and position data. Such data about the sensors may include, for example, the percentage likelihood of valid data which may be determined by the number of satellites communicatively connected to the vehicle, the strength of one or more signals capturing motion data, and more.

In some embodiments, upon the motion data being received by the system, the motion data may be recorded to and/or or stored within, e.g., a client device on or within the vehicle, one or more remote cloud servers or cloud storage locations, or any other computer or storage device within or communicatively connected to the system.

At step 220, the system processes the motion data for adjustments. In some embodiments, the system processes the motion data to compensate for orientation of the vehicle being slightly off in comparison to other motion data. For example, if a car is not pointed forward, or is tilted, then the system adjusts the motion data to compensate for that. Similarly, if a photo is being captured on a user's smartphone to provide motion data, and the screen or phone is pointed towards the person, e.g. a 45-degree angle relative to the car, then the system attempts to preparing that data in reference to the orientation of the car. In various embodiments, the adjustments may include minor conditioning of the data or more significant conditioning.

In some embodiments, processing the motion data for adjustments can include down sampling of the data when needed for some use cases. For example, an accelerometer sensor may be able to record up to a few kilohertz, but the system may require only 1-2 kilohertz, so the data can be down sampled to reduce the size of the data accordingly.

In some embodiments, processing for adjustments can include adjusting the motion data to prepare and/or clean the data for further processing, derivations of other relevant data, and more. In some embodiments, the adjustments involve the system applying one or more filters which may be needed to clean up the data and prepare it for further calculations and derivations. In some embodiments, the system may need to apply transformations of one or more coordinate systems corresponding to the data, which are transformed to different coordinate systems. In some embodiments, the system may flag and/or discard extraneous data (i.e., redundancies) or abnormalities in the data. In some embodiments, extraneous data may come from, e.g., natural noise found in the sensors, vibrations, solar flares, radiation, or any other source of extraneous data. In some embodiments, abnormalities in the data may be caused by, e.g., inconsistent data coming in from the sensors. Such inconsistent data may be due to, for example, users within the network-connected platform attempting to circumvent designation rules and procedures, or may be the result of, e.g., natural occurrences, misuse, broken sensors, false data, or any other suitable cause of inconsistencies within the data.

In various embodiments, the data processing may be done on a device, such as the client device placed within or on a vehicle, in a vehicle computer, in a remote cloud server, or any other suitable location for data processing.

In some embodiments, the data is processed using one or more machine learning techniques. This may include, for example, machine vision and/or computer vision techniques.

At step 230, the system determines maximum acceleration data for the vehicle. In some embodiments, acceleration data is derived from velocity or position data. In some embodiments, the acceleration may be converted into G (i.e., multiples of gravity force). In some embodiments, the maximum deceleration, forward acceleration and cornering acceleration can be found from the motion data.

At step 240, the system calculates a performance metric (“PM”) for the vehicle. In some embodiments, this calculation is based on the maximum acceleration data. In some embodiments, the calculation is additionally based on one or more correction factors. In some embodiments, the maximum acceleration data from previous step 230 are multiplied with correction factors to get the PM. In some embodiments, the PM represents a scaling of the acceleration data based on various factors (such as, e.g., correction factors). Correction factors may include, for example, how much a vehicle corners and how much its braking is dependent on its tire grip, which in turn is based on weather conditions, for example, whether the conditions are hot, cold, wet, etc. In some embodiments, another correction factor may represent how much grip a car's tires have, which may be car-dependent.

In some embodiments, one correction factor is braking. This correction factor may consist of multiple variables that may take into account, e.g., weather (such as, for example, rain, humidity, or temperature), track factors (such as camber, grip levels, etc.) elevation, or any other suitable variables which affect braking in a vehicle.

In some embodiments, one of the correction factors is cornering. This correction factor may consist of multiple variables that may take into account, e.g., weather (such as rain, humidity, temperature), track factors (such as camber, grip levels, etc.), elevation, or any other suitable variables which affect cornering in a vehicle.

In some embodiments, one of the correction factors is forward correction. This correction factor may consist of multiple variables that may take into account, e.g., gear shift times, weather (such as rain, humidity, or temperature), track factors (such as camber, grip levels, etc.), elevation, or lap factors, such as the number or length of “straights”, i.e., straight sections of track. In some embodiments, a car that is able to achieve much higher speeds than other cars may need correction. In some embodiments, vehicles that accelerate differently relative to speed may need special factors to account for this discrepancy between vehicles.

In some embodiments, one of the correction factors is a total correction factor. This factor might consist of multiple variables to, e.g., keep competition close, or to manage classes overall, driver skill, time, sensor inconsistencies, or any other factors which affect overall performance.

In some embodiments, one of the correction factors is speed. This can be used to scale a speed metric as needed, as will be shown below.

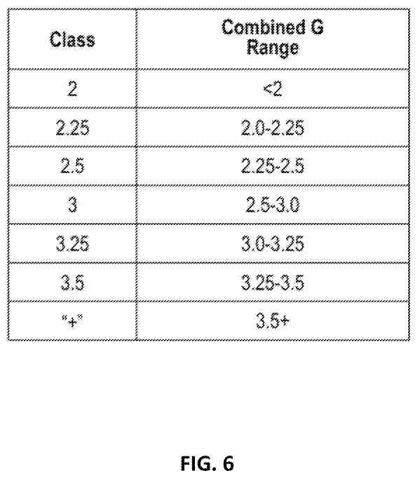

FIG. 6 is a diagram illustrating one example embodiment of a vehicle classification system based on combined G range. The illustration depicts an example of how the classes might be divided if all correction factors are set to 1 and max accelerations are calculated. In some embodiments, example equations may include, for example:

Performance Metric,PM=(Cfb*Ab+Cfc*Ac+Cff*Af)*Cft+Sm+Rm

where Ab represents Maximum Braking Acceleration, Ac represents Maximum Corning Acceleration, Af represents Maximum Forward Acceleration, Cfb represents a Correction Factor for Braking, Cfc represents a Correction Factor for Cornering, Cff represents a Correction Factor for Forward Correction, Cft represents a Correction Factor for Total Correction, Sm represents a Speed Metric (as applied in the equation below), and Rm represents a Rotation Metric. In some embodiments, data from gyroscopes could be used to determine the rate of rotation. How quickly a car rotates helps a car get around corners faster than one that does not rotate quickly.

Sm=Cfs*Sx/St

where Cfs represents a Correction Factor for Speed, Sx represents the Top Speed of Vehicle X on the Track, and St represents the Top Speed of the Fastest Recorded Vehicle (i.e., Reference Vehicle) on the Track.

In some embodiments, the Rotation Metric is multiplied by Cfc*Ac in the PM equation above.

In some embodiments, the correction factor variables do not represent linear relationships as variables, but polynomial functions. For example, how rain affects the grip levels might be a non-linear relationship since a little rain doesn't affect grip much, but once there is standing water, the racing line needs to change and grip levels are significantly different. One could imagine then that the Correction Factor for Rain might be the precipitation amount in a polynomial function with a step function.

In some embodiments, the algorithm could be a machine learning algorithm, or other artificial intelligence processes, taught using the data from step 10, and outputting a handicap factor and/or class.

At step 250, the system assigns one or more designations to the vehicle based on the performance metric.

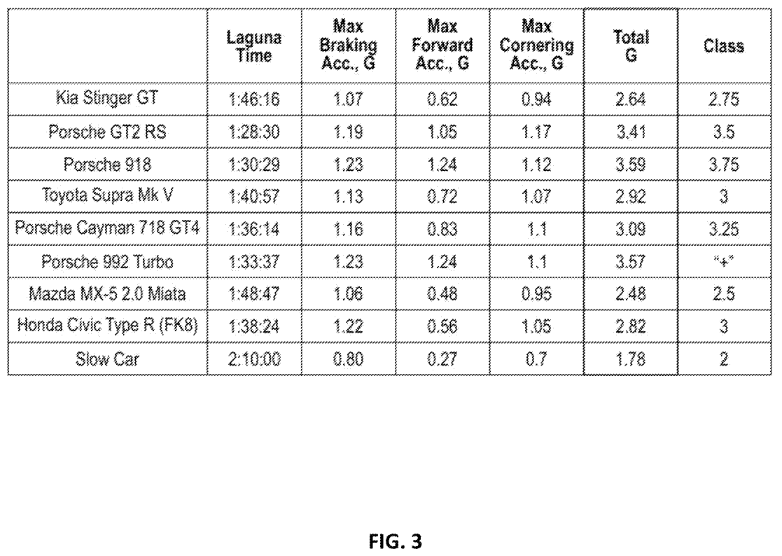

In some embodiments, once the Performance Metric is determined, classes can be split up across the spectrum of calculated Performance Metrics. FIG. 3 describes one such example of how this may be performed. In some embodiments, a multitude of classes may be assigned in such a way. In some embodiments, a group of users of the platform may be required to determine how many classes they think is best to keep competition close, but also have class sizes large enough.

In some embodiments, the system could be alternatively or additionally used to create handicaps for racers to compete closely with one another when in cars with different performance metrics. At least a subset of the assigned designations would relate to handicaps to be applied to the racers in question.

For example, the system may determine that the slower car should have a handicap of 10 seconds compared to a race car, so if they were to compete the slow car would get 10 seconds removed from their lap time when compared to the race car. This would be a system similar to handicaps in golf.

In varying embodiments, the system could create just classes, just handicap factors, or both classes and handicap factors.

In some embodiments, the classes may be used for time trial racing or wheel to wheel racing. As an example, the estimated time a vehicle takes to complete a lap can be calculated by:

Tex=Cfex*PMx

where Tex represents a Time Estimate of Vehicle X, Cfex represents a Correction Factor Time Estimate for Vehicle X, which converts from PM to time for a given track, and PMx represents a Performance Metric for Vehicle X. Or:

Tef=Cfef*PMf

Where Tef represents a Time Estimate of the Fastest Vehicle, Cfef represents a Correction Factor Time Estimate for the Fastest Recorded Vehicle (i.e., Reference Vehicle), which will convert from PM to time for a given track, and PMf represents a Performance Metric for the Fastest Recorded Vehicle (i.e., Reference Vehicle).

In some embodiments, the Handicap Time, Ht, for example, could be calculated by:

Ht=Tex−Tef

Where Tex represents a Time Estimate of Vehicle X, and Tef represents a Time Estimate of the Fastest Recorded Vehicle (Reference Vehicle).

In some embodiments, the handicap could be a multiplication factor that would be applied to a racer's time to better compare between fast and slow vehicles. For example, a slow vehicle could get a multiplication factor of 0.70 while a fast vehicle would have a multiplication number of 0.98. Their time would then be multiplied by their factor to get a time that they can compare and compete with. These factors would be created once the lap times and max accelerations of all the vehicles are measured and compared. This would allow drivers to compete more on skill than vehicle.

In some embodiments, the Handicap Factor, Hf, for example, could be calculated by:

Hf=Cfh*PMx/PMf

where Cfh represents a Correction Factor for Handicap. This could consist of variables to account for different tracks, and to convert from Performance Metric to lap times, PMx represents a Performance Metric of Vehicle X, and PMf represents a Performance Metric of the Fastest Recorded Vehicle (i.e., Reference Vehicle).

In some embodiments, the factors could be presented as, e.g., a percent, fraction, score or a different type of point system. In some embodiments, the Reference Vehicle can be any consistent vehicle. For example, it could be the slowest vehicle, or a vehicle in the middle in terms of speed.

At step 260, the system presents the one or more designations of the vehicle to one or more users of a network-connected platform.

In some embodiments, for example, the designations for the vehicle are presented to users as class designations for the vehicle from a prespecified list of racing classes. This may be presented to a racer, a group of racers, or publicly to anyone accessing the platform. In some embodiments, the designations for the vehicle are presented as one or more handicap designations to be applied to a racer and their selected vehicle for a particular race. In some embodiments, advertising content and materials may be presented within the platform or external platforms or websites based on the assigned designations for a user. Such advertising content can be customized to the user based on the assigned designations. In some embodiments, the system may present driver training content to one or more users of the network-connected platform based on the assigned designations of the vehicle.

In some embodiments, the system matches, based on the assigned designations, a user of the network-connected platform associated with the vehicle with one or more additional users of the network-connected platform whose associated vehicles have been assigned the same or similar designations. In some embodiments, the matching of users occurs for users associated with vehicles differing in one or more of: modifications performed on the vehicle, make of the vehicle, or model of the vehicle.

FIG. 3 is a diagram illustrating one example embodiment of using motion data to provide class designations for vehicles.

The illustration shows an example of how acceleration (“G”) could be used to determine class ranking of vehicles in motorsports, in particular when all correction factors are set to 1 and max acceleration data is calculated.

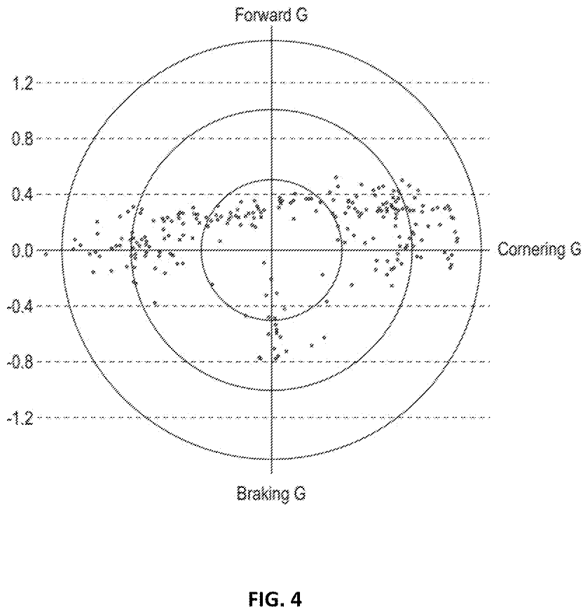

FIG. 4 is a diagram illustrating one example of a standard acceleration plot of a vehicle.

The illustration shows an example plot of acceleration of a vehicle, such as, e.g., a race car. The plot shown depicts the maximum lateral and longitudinal accelerations exhibited by the vehicle.

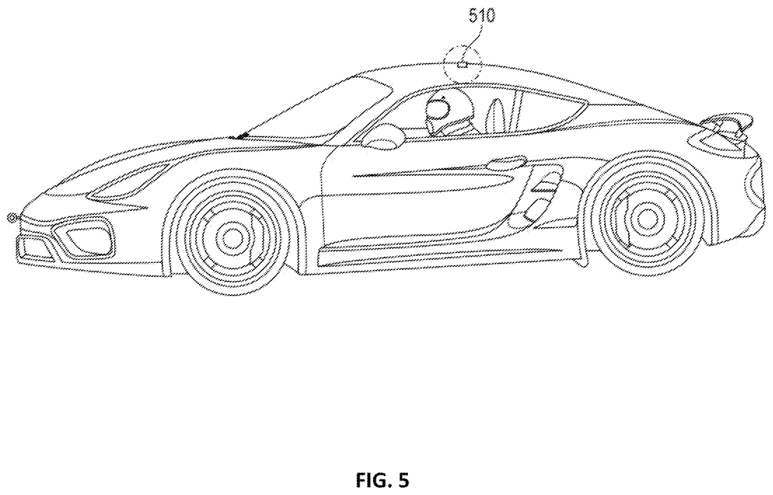

FIG. 5 is a diagram illustrating one example embodiment of a sensor external to a vehicle for capturing motion data.

The illustration depicts an external sensor which is situated on top of a vehicle. The external sensor in the example is a Global Positioning System (“GPS”) transponder which is placed on top of a car. The transponder is capable of capturing the GPS coordinates of the car as it travels along roads. Based on this GPS data, motion data may be derived, including maximum acceleration data for a particular section of roads, a particular designated race course, or more generally while the vehicle is in operation.

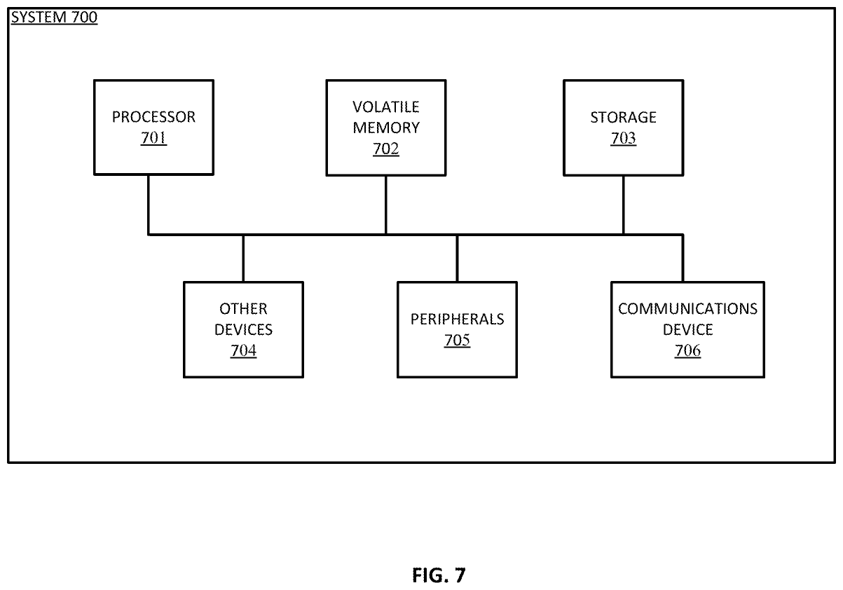

FIG. 7 is a diagram illustrating an exemplary computer that may perform processing in some embodiments. Exemplary computer 700 may perform operations consistent with some embodiments. The architecture of computer 700 is exemplary. Computers can be implemented in a variety of other ways. A wide variety of computers can be used in accordance with the embodiments herein.

Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Peripherals 705 may include removable media devices such as CD-R and DVD-R recorders/players. Communications device 706 may connect the computer 100 to an external medium. For example, communications device 706 may take the form of a network adapter that provides communications to a network. A computer 700 may also include a variety of other devices 704. The various components of the computer 700 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method, comprising:
receiving motion data for a vehicle, the motion data being captured from one or more sensors;
processing the motion data for adjustments;
determining maximum acceleration data for the vehicle;
calculating a performance metric for the vehicle based on the maximum acceleration data;
assigning one or more designations to the vehicle based on the performance metric; and
presenting the one or more designations of the vehicle to one or more users of a network-connected platform.

2. The method of claim 1, wherein the one or more sensors are attached to a client device operating within or in proximity to the vehicle.

3. The method of claim 1, wherein the one or more sensors are of sensor types comprising one or more of: accelerometers, GPS sensors, satellites, computers, cameras, microphones, optical sensors, magnetic sensors, radars, and gyroscopes.

4. The method of claim 1, wherein the motion data comprises one or more of: vehicle acceleration, velocity, and position data.

5. The method of claim 1, wherein calculating the performance metric for the vehicle is further based on one or more correction factors.

6. The method of claim 1, wherein processing the motion data and assigning designations to the vehicle are performed using one or more machine learning techniques.

7. The method of claim 1, wherein processing the motion data comprises applying one or more filters to clean the data.

8. The method of claim 1, wherein processing the motion data comprises applying transformations to one or more coordinate systems represented within the motion data.

9. The method of claim 1, wherein processing the motion data comprises flagging or discarding detected redundancies or abnormalities in the motion data.

10. The method of claim 1, wherein the maximum acceleration data comprises at least a maximum longitudinal acceleration and a maximum lateral acceleration.

11. The method of claim 1, wherein the maximum acceleration data is derived from one of:
velocity data or position data.

12. The method of claim 1, wherein the maximum acceleration data comprises one or more of: a maximum deceleration, a forward acceleration, and a cornering acceleration for the vehicle.

13. The method of claim 1, wherein the designations for the vehicle comprise at least a racing class designation from a prespecified list of racing classes.

14. The method of claim 1, wherein the designations for the vehicle comprise at least one or more handicap designations.

15. A communication system comprising one or more processors configured to perform the operations of:
receiving motion data for a vehicle, the motion data being captured from one or more sensors;
processing the motion data to prepare and/or clean the motion data;
determining maximum acceleration data for the vehicle;
calculating a performance metric for the vehicle based on the maximum acceleration data and one or more correction factors;
assigning one or more designations to the vehicle based on the performance metric; and
presenting the one or more designations of the vehicle to one or more users of a network-connected platform.

16. The communication system of claim 15, wherein the one or more processors are further configured to perform the operation of:
presenting one or more pieces of advertising content customized for the one or more users of the network-connected platform based on the assigned designations of the vehicle.

17. The communication system of claim 15, wherein the one or more processors are further configured to perform the operation of:
presenting driver training content to the one or more users of the network-connected platform based on the assigned designations of the vehicle.

18. The communication system of claim 15, wherein the one or more processors are further configured to perform the operation of:
matching, based on the assigned designations, a user of the network-connected platform associated with the vehicle with one or more additional users of the network-connected platform whose associated vehicles have been assigned the same or similar designations.

19. The communication system of claim 18, wherein the matching of users occurs for users associated with vehicles differing in one or more of: modifications performed on the vehicle, make of the vehicle, or model of the vehicle.

20. A non-transitory computer-readable medium containing instructions, comprising:
instructions for receiving motion data for a vehicle, the motion data being captured from one or more sensors;
instructions for processing the motion data to prepare and/or clean the motion data;
instructions for determining maximum acceleration data for the vehicle;
instructions for calculating a performance metric for the vehicle based on the maximum acceleration data and one or more correction factors;
instructions for assigning one or more designations to the vehicle based on the performance metric; and
instructions for presenting the one or more designations of the vehicle to one or more users of a network-connected platform.
